(19) United States
(12) Patent Application Publication
(10) Pub. No.: US 2024/0066836 A1
(43) Pub. Date: Feb. 29, 2024

(54) HIGHLY THERMALLY CONDUCTIVE HYBRID CARBON FIBER COMPOSITES AND METHODS FOR MAKING AND USING THE SAME

(71) Applicant: United States of America as represented by the Administrator of NASA, Washington, DC (US)

(72) Inventors: Jin Ho Kang, Newport News, VA (US); Keith L. Gordon, Hampton, VA (US); Grace A. Belancik, Sunnyvale, CA (US); Pranav Tolaram Jagtap, San Jose, CA (US)

(21) Appl. No.: 18/222,126

(22) Filed: Jul. 14, 2023

Related U.S. Application Data
(60) Provisional application No. 63/454,291, filed on Mar. 23, 2023.
(60) Provisional application No. 63/437,248, filed on Jan. 5, 2023.
(60) Provisional application No. 63/401,379, filed on Aug. 26, 2022.

(51) Int. Cl. B32B 9/04; B32B 3/26; B32B 5/02; B32B 7/027; B32B 7/12; B32B 9/00; B32B 27/12; B32B 37/06; B32B 37/18; B32B 38/04

(52) U.S. Cl. CPC B32B 9/047; B32B 3/266; B32B 5/024; B32B 7/027; B32B 7/12; B32B 9/007; B32B 9/045; B32B 27/12; B32B 37/06; B32B 37/182; B32B 38/04; B32B 2038/047; B32B 2260/021; B32B 2260/046; B32B 2262/106; B32B 2305/076; B32B 2307/302; B32B 2307/54; B32B 2307/72; B32B 2307/7376; B32B 2310/0831; B32B 2310/14; B32B 2313/04

(57) ABSTRACT

Described herein are highly thermally conductive hybrid carbon fiber composites. The composites are composed of one or more alternating layers of (a) a pyrolytic graphite sheet and (b) carbon fibers impregnated with a resin. The thermal conductivity of the composites is substantially higher when compared independently to the pyrolytic graphite sheet and carbon fibers. In addition to increased thermal conductivity, the composites possess other desirable properties such as increased thermal emissivity and solar absorptivity. The enhanced properties of the composites make them suitable for use in a number of different applications where heat flow is desirable.

### CROSS-REFERENCE TO RELATED PATENT APPLICATION(S)

This patent application claims the benefit of and priority to U.S. Patent Application Nos. 63/401,379, filed on Aug. 26, 2022; 63/437,248, filed Jan. 5, 2023; and 63/454,291, filed Mar. 23, 2023; the contents each of which are hereby incorporated by reference in their entireties.

### STATEMENT REGARDING FEDERALLY SPONSORED RESEARCH OR DEVELOPMENT

The invention described herein was made by employees of the United States Government and may be manufactured and used by or for the Government of the United States of America for governmental purposes without the payment of any royalties thereon or therefore.

### BACKGROUND OF THE INVENTION

Carbon fiber reinforced polymer composites have been used for aerospace structures because they have low mass, high specific strength, high specific stiffness, and low life-cycle maintenance compared to aluminum alloys. However, the relatively low thermal conductivities of carbon fiber (CF) polymer composites fail to provide effective heat flow for certain applications such as heat exchanging systems and radiators.¹ The thermal conductivity of carbon fiber polymer composites is about 0.7 W/m·K to 5 W/m·K which is only 0.5% to 3% of that of aluminum alloy 6061. Carbon nanotubes (CNTs) have been known as highly thermally conductive materials. Single-walled CNT has a thermal conductivity of about 200 W/m·K and multiwalled CNT about 3000 W/m·K. Graphene nano-sheets have a similar level of thermal conductivity of CNT.²⁻³ Many research groups have attempted to improve thermal conductivity by incorporating CNTs, graphene nano-sheets or CNT sheets.^{1,4-5} Pyrolytic graphite sheet (PGS) with a high thermal conductivity of about 400 W/m·K to 1950 W/m·K has been developed and a radiator fabricated with the PGS have been reported.⁶⁻⁹

However, the thermal conductivity for CNTs, graphite nanosheets or CNT sheets incorporated composites was measured to be only about 5 W/m·K to 10 W/m·K which is not high enough for the radiator or heat exchanger applications. Pyrolytic graphite sheets stacked with layers of adhesives have low stiffness and low out-of-plane thermal conductivity due to the adhesive.¹⁰⁻¹¹ The composites described herein address the shortcomings of these materials.

### BRIEF SUMMARY OF THE INVENTION

Described herein are highly thermally conductive hybrid carbon fiber composites. The composites are composed of one or more alternating layers of (a) a pyrolytic graphite sheet and (b) carbon fibers impregnated with a resin. The thermal conductivity of the composites is substantially higher when compared independently to the pyrolytic graphite sheet and carbon fibers. In addition to increased thermal conductivity, the composites possess other desirable properties such as increased thermal emissivity and solar absorptivity. The enhanced properties of the composites make them suitable for use in a number of different applications where heat flow is desirable.

In one aspect, the composite comprises:
a first substrate having a first side and a second side, wherein the first substrate comprises a first pyrolytic graphite sheet, and
a second substrate having a first side and a second side, wherein the second substrate comprises carbon fibers and a resin,
   wherein the first side the second substrate is adjacent to and adhered to the second side of the first substrate by the resin.

In another aspect, the composite is produced by the method comprising
(a) coupling a first substrate with a second substrate to produce a first stack, wherein the first substrate has first side and a second side, wherein the first substrate comprises a pyrolytic graphite sheet, and the second substrate has a first side and a second side, wherein the second substrate comprises carbon fibers and a resin, and wherein the first side the second substrate is adjacent to the second side of the first substrate; and
(b) heating the first stack to adhere the first substrate with the second substrate to produce the composite.

In another aspect, described herein are devices that include the composites as provided herein.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

FIG. 1 shows the assembly of a composite with a pyrolytic graphite sheet-carbon fiber (PGS-CF) configuration.

FIG. 2 shows the assembly of a composite with a carbon fiber-pyrolytic graphite sheet-carbon fiber (CF-PGS-CF) configuration.

FIG. 3 shows the assembly of a composite with a pyrolytic graphite sheet-carbon fiber-pyrolytic graphite sheet (PGS-CF-PGS) configuration.

FIGS. 4A-4D shows the surface and (A and B) and cross-sectional morphology (C and D) of PGS.

FIG. 5 shows the cross-sectional morphology of CF-epoxy/PGS 70/CF-epoxy composite.

FIG. 6A-6B shows the cross-sectional morphology of CF-epoxy/PGS 70/CF-epoxy composite after polishing.

FIG. 7 shows the in-plane thermal conductivity of PGS and CF-Epoxy/PGS composite.

FIG. 8 shows the in-plane and out-of-plane thermal conductivity of CF-Epoxy/PGS composite and CNT_CF-Epoxy/perforated PGS composite.

FIG. 9 shows the in-plane thermal conductivity of pitch-based CF-Epoxy/PGS composite.

FIG. 10 shows the thermal emissivity (ϵ_{T}) and solar absorptivity (αₛ) of PGS and CF-Epoxy/PGS composite.

### DETAILED DESCRIPTION OF THE INVENTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of” Similarly, the term “consisting essentially of” is intended to include examples encompassed by the term “consisting of.”

As used in the specification and the appended claims, the singular forms “a,” “an” and “the” include plural referents unless the context clearly dictates otherwise. Thus, for example, reference to “a solvent” include, but are not limited to, mixtures or combinations of two or more such solvents, and the like.

Identifiers such as, for example, “first pyrolytic graphite sheet” and “second pyrolytic graphite sheet” are provided herein and are used to distinguish different components.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation including: matters of logic with respect to arrangement of steps or operational flow; plain meaning derived from grammatical organization or punctuation; and the number or type of embodiments described in the specification.

Disclosed are the components to be used to conduct the methods of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

As used herein, the terms “optional” or “optionally” means that the subsequently described event or circumstance can or cannot occur, and that the description includes instances where said event or circumstance occurs and instances where it does not.

As used herein, the terms “cure” and “curing” encompass polymerizing and/or crosslinking of a resin or polymeric material brought about by mixing of reactive based components with a functionality of two or more, heating at elevated temperatures, and/or exposing the materials to ultraviolet light and radiation.

The term a “fully cured” resin as used herein refers to when the curable no longer undergoes polymerization. As known in the art, even when using the term “fully cured” there may still regularly be some residual functional groups that have not polymerized or cross-linked due to chain end mobility or other known reasons. In some embodiments, a “fully cured” resin or composition may contain less than about 1%, about 0.1%, or about 0.01% residual reactive functional groups as determined by the molar percentage of the initial total moles of functional groups in a material.

In one aspect, the degree of cure (DoC) can be measured by differential scanning calorimetry (DSC). Differential scanning calorimetry (DSC) is used to measure the exotherm due to the enthalpy of polymerization. For example, an uncured (0% degree of cure, DoC) sample is cured in the DSC to the maximum extent of reaction attainable to measure the total heat of reaction (THR). A new sample of the same material at an unknown DoC can be placed in the DSC and put through the same cure process to measure the residual heat of reaction (RHR). The extent of cure of the unknown sample is then taken as (1-RHR/THR)×100%.

In another aspect, the (DoC) can be measured by spectroscopy. Infrared, near infrared, and Raman spectroscopy can be used to quantify the concentrations of reactive functional groups in a polymer. When a clearly discernable peak associated with a limiting functional group can be identified in the spectrum, then it is possible to directly track the consumption of that functional group (and the DoC) by collecting spectral data at various stages of cure. The peak area or peak height can be used to quantify the concentration of the functional group(s) associated with that peak(s).

The term a “partially cured” resin may contain more than about 10%, about 20%, about 30%, about 50%, about 60%, about 70%, about 80%, or about 90% residual reactive functional groups as determined by the molar percentage of the initial total moles of functional groups in the material. The term “partially cured” also refers to the point at which the curable resin is less than the gel point of the curable resin. The term “gel point” as defined herein as the DoC where the polymer first forms an infinite network, the material becomes insoluble, and the material takes on an elastic modulus. In one aspect, the gel point of the curable resin can be measured rheologically using dynamic mechanical analysis (DMA) or a torsional (e.g., parallel plate) rheometer. An oscillatory mechanical test is carried out during the resin cure process. The gel point is identified by the point where the measured storage modulus exceeds the measured loss modulus. During the dynamic testing, the material is heated according to a cure cycle (time and temperature is measured) while the storage and loss moduli are measured. Either DSC or spectral techniques are used to determine the DoC of the material due to the applied cure cycle. Once you have both the rheology and DoC measurements, the DoC at the gel point can be determined.

As used herein, the term “faying surface” is the surface or of a material or layer that interfaces with the faying surface of a second material or layer. The two layers are adjacent to (i.e., in contact with) one another at the faying surface of each layer.

As used herein, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Unless otherwise specified, temperatures referred to herein are based on atmospheric pressure (i.e. one atmosphere).

It is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

### Composites

Described herein are highly thermally conductive hybrid carbon fiber composites. The composites are composed of one or more alternating layers of (a) a pyrolytic graphite sheet and (b) carbon fibers impregnated with a resin. The thermal conductivity of the composites is substantially higher when compared independently to the pyrolytic graphite sheet and carbon fibers. In addition to increased thermal conductivity, the composites possess other desirable properties such as increased thermal emissivity and solar absorptivity. The enhanced properties of the composites make them suitable for use in a number of different applications where heat flow is desirable.

In one aspect, the composite comprises:
a first substrate having a first side and a second side, wherein the first substrate comprises a first pyrolytic graphite sheet, and
a second substrate having a first side and a second side, wherein the second substrate comprises carbon fibers and a resin,
   wherein the first side the second substrate is adjacent to and adhered to the second side of the first substrate by the resin.

In another aspect, the composite is produced by the method comprising
(a) coupling a first substrate with a second substrate to produce a first stack, wherein the first substrate has first side and a second side, wherein the first substrate comprises a pyrolytic graphite sheet, and the second substrate has a first side and a second side, wherein the second substrate comprises carbon fibers and a resin, and wherein the first side the second substrate is adjacent to the second side of the first substrate; and
(b) heating the first stack to adhere the first substrate with the second substrate to produce the composite.

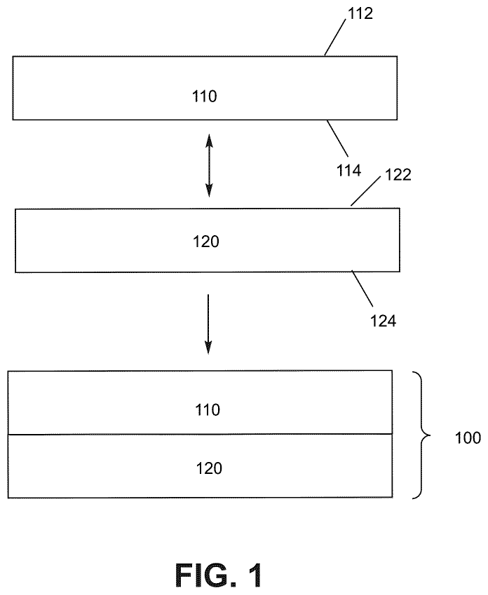

Referring to FIG. 1, the first substrate 110 with a first side 112 and a second side 114 is coupled with a second substrate 120, where the first side 122 of the second substrate is adjacent to and adhered to the second side 114 of the first substrate to produce composite 100. The composite depicted FIG. 1 is a two-layer system composed of a layer of a pyrolytic graphite sheet (PG) and a layer of carbon fibers (CF). The first and second substrates are adhered to one another by a resin, which is applied to second substrate prior to coupling with the first substrate. The resin can be applied to the second substrate using techniques known in the art. For example, the resin can be topically applied to the first surface of the second substrate (i.e., carbon fibers) by spraying or painting the resin on the carbon fibers. In other aspects, the carbon fibers can be dipped into a solution of the resin.

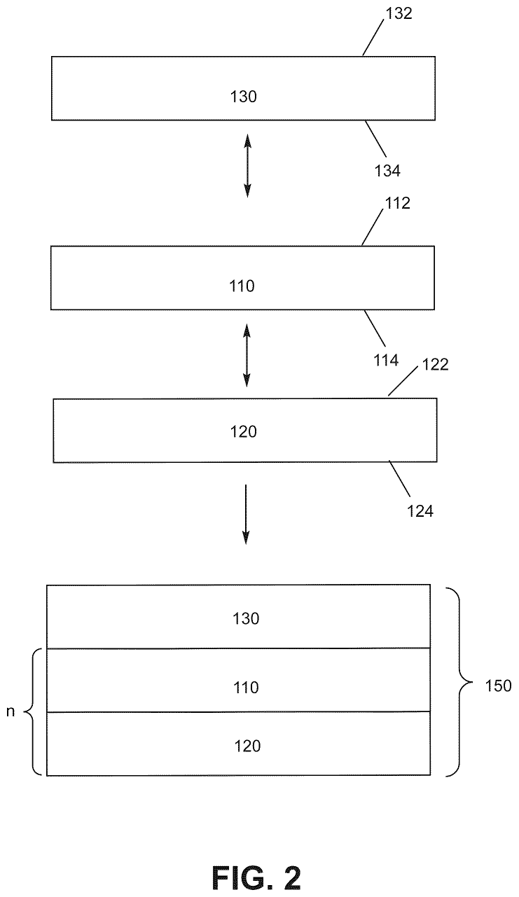

FIG. 2 depicts another configuration of the composite. Referring to FIG. 2, a third substrate 130 having a first side 134 and a second side 132, wherein the third substrate 130 comprises carbon fibers and a resin, wherein the first side 134 of the third substrate 130 is adjacent to and adhered to the first side 112 of the first substrate 110. In this configuration, the composite 150 is a three-layer system composed of carbon fibers (CF)-pyrolytic graphite sheet (PG)-carbon fibers (CF). The number of pyrolytic graphite sheet (PG)-carbon fibers (CF) repeat layers can vary. This is depicted in FIG. 2, where n is an integer from 1 to 1,000, where there are from 1 to 1,000 PG-CF layers in the composite.

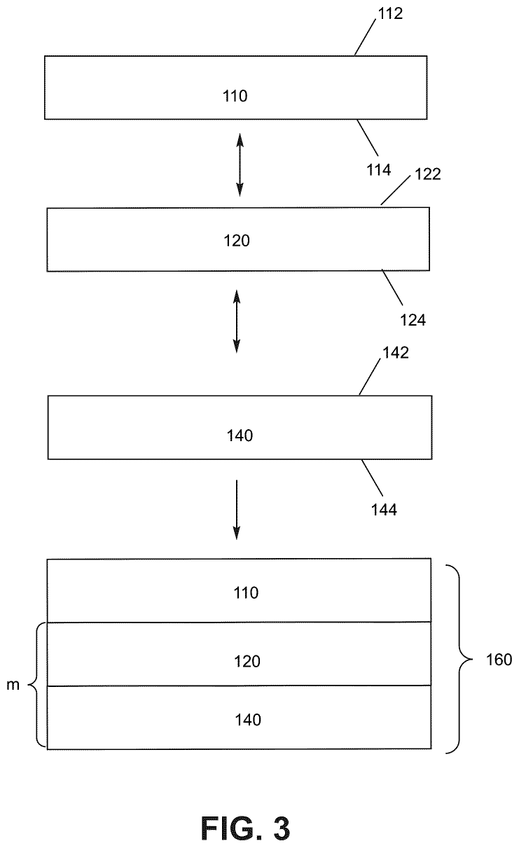

FIG. 3 depicts another configuration of the composite. Referring to FIG. 3, a third substrate 140 having a first side 142 and a second side 144, wherein the third substrate 140 comprises pyrolytic graphite sheet, wherein the first side 142 the third substrate 140 is adjacent to and adhered to the second side 124 of the second substrate 120. In this configuration, the composite 160 is a three-layer system composed of pyrolytic graphite sheet (PG)-carbon fibers (CF)-pyrolytic graphite sheet (PG). The number of carbon fibers (CF)-pyrolytic graphite sheet (PG) repeat layers can vary. This is depicted in FIG. 3, where m is an integer from 1 to 1,000, where there are from 1 to 1,000 CF-PG layers in the composite.

In another aspect, the composite is composed of carbon fibers (CF) and pyrolytic graphite sheet (PG) repeat layers arranged in a random order. In this aspect, the number and relative position of the carbon fibers (CF) and pyrolytic graphite sheet (PG) can vary. For example, composite could be composed of a random unit composed of PG-PG-CF-CF-PG-CF-PG, where CF and PG are arranged in no particular order. The number of random units can vary. In one aspect, the number of random units is from 1 to 1,000.

The number of layers of the pyrolytic graphite sheet (PG) and carbon fibers (CF) can vary depending upon the application of the composite. For example, the thickness of the composite can be adjusted to modify the thermal conductivity properties of the composite. Thus, multiple alternating layers of pyrolytic graphite sheets and carbon fibers can be assembled to produce composites with fine-tuned properties such as thermal conductivity. Additionally, the outer most layers of the composite can be composed of carbon fibers as depicted in FIG. 2 or pyrolytic graphite sheets as depicted in FIG. 3. Alternatively, one outer surface of the composite of can be composed of carbon fibers and the other outer surface can be composed of pyrolytic graphite sheet as depicted in FIG. 1.

In one aspect, the pyrolytic graphite sheet and carbon fibers with resin can be stacked upon each other to produce a stack with a desired thickness. After the stack is formed, the stack is heated to cure the resin present in the carbon fibers (i.e., second substrate) under pressure. In one aspect, the stack is heated at a temperature of from about 70° C. to about 300° C., or 70° C., 90° C., 100° C., 125° C., 150° C., 175° C., 200° C., 225° C., 250° C., 275° C., or 300° C., where any value can be a lower and upper endpoint of a range (e.g., 90° C. to 125° C.). In one aspect, the pressure is about 1 psi to about 200 psi, or about 1 psi, 5 psi, 10 psi, 20 psi, 50 psi, 100 psi, 150 psi, or 200 psi, where any value can be a lower and upper endpoint of a range (e.g., 5 psi to 20 psi). In one aspect, consolidation or curing of the pyrolytic graphite sheet and carbon fiber with resin can be performed under extra vacuum. In one aspect, the vacuum level is about 1 psi to about 20 psi, or about 1 psi, 5 psi, 10 psi, 15 psi, or 20 psi, where any value can be a lower and upper endpoint of a range (e.g., 5 psi to 14.7 psi).

### Pyrolytic Graphite Sheet

The pyrolytic graphite sheets used herein are composed of highly oriented graphene multilayers. The pyrolytic graphite sheets useful herein have desirable properties with respect to imparting enhanced thermal conductivity to the composites.

In one aspect, the pyrolytic graphite sheet has an in-plane thermal conductivity of from about 300 W/m·K to about 2,500 W/m·K, or about 300 W/m·K, 500 W/m·K, 700 W/m·K, 900 W/m·K, 1,100 W/m·K, 1,300 W/m·K, 1,500 W/m·K, 1,700 W/m·K, 1,900 W/m·K, 2,100 W/m·K, 2,300 W/m·K, or 2,500 W/m·K, where any value can be a lower and upper endpoint of a range (e.g., 500 W/m·K to 1,300 W/m·K).

In one aspect, the pyrolytic graphite sheet has a through-plane thermal conductivity of from about 1 W/m·K to about 40 W/m·K, or 1 W/m·K, 5 W/m·K, 10 W/m·K, 20 W/m·K, 25 W/m·K, 30 W/m·K, 35 W/m·K, or 40 W/m·K, where any value can be a lower and upper endpoint of a range (e.g., 10 W/m·K to 35 W/m·K).

In one aspect, the pyrolytic graphite sheet has a thermal diffusivity of from about 5 cm²/s to about 20 cm²/s, or about 5 cm²/s, 7 cm²/s, 9 cm²/s, 11 cm²/s, 13 cm²/s, 15 cm²/s, 17 cm²/s, 19 cm²/s, 21 cm²/s, 23 cm²/s, or 25 cm²/s, where any value can be a lower and upper endpoint of a range (e.g., 13 cm²/s to 21 cm²/s).

In one aspect, the pyrolytic graphite sheet has a density of from about 0.5 g/cc to about 2.5 g/cc, or about 0.5 g/cc, 0.7 g/cc, 1.1 g/cc, 1.3 g/cc, 1.5 g/cc, 1.7 g/cc, 1.9 g/cc, 2.1 g/cc, 2.3 g/cc, or 2.5 g/cc, where any value can be a lower and upper endpoint of a range (e.g., 0.7 g/cc to 1.3 g/cc).

In one aspect, the pyrolytic graphite sheet is a sheet having a thickness of from about 10 micrometers to about 150 micrometers, or about 10 micrometers, 20 micrometers, 30 micrometers, 40 micrometers, 50 micrometers, 60 micrometers, 80 micrometers, 90 micrometers, 100 micrometers, 110 micrometers, 120 micrometers, 130 micrometers, 140 micrometers, or 150 micrometers, where any value can be a lower and upper endpoint of a range (e.g., 20 micrometers to 100 micrometers).

In certain aspects, the pyrolytic graphite sheet can be further processed prior to forming the composite. In one aspect, the pyrolytic graphite sheet is exposed to ultraviolet light or surface plasma. In another aspect, the pyrolytic graphite sheet can be perforated to produce a plurality of holes in the sheet. The number of holes as well as the diameter of the holes can vary. Not wishing to be bound by theory, the present of the holes in the pyrolytic graphite sheet can enhance the thermal conductivity of the final composite.

In one aspect, the pyrolytic graphite sheets manufactured by Panasonic Industry (Japan) and HPMS Graphite (US) can be used to produce the composites described herein.

Carbon Fibers with Resin

The carbon fibers with resin are also referred to herein as prepegs. The term “prepreg” as defined herein, refers to a layer of carbon fiber material (e.g., fibers, unidirectional fibers, unidirectional tows or tape, non-woven mat, and/or fabric ply) that has been impregnated with a curable resin as described herein. Prepregs may be manufactured by infusing or impregnating continuous fibers or woven fabric with a curable resin, creating a pliable and tacky sheet of material. This is often referred to as a prepregging process. The precise specification of the fibers, their orientation and the formulation of the resin matrix can be specified to achieve the optimum performance for the intended use of the prepregs. The volume of fibers per square meter can also be specified according to requirements. The fiber reinforcement material may be in the form of a woven or nonwoven fabric ply, or continuous unidirectional fibers. The term “unidirectional fibers” as used herein, refers to a layer of reinforcement fibers that are aligned in the same direction.

In one aspect, the carbon fibers in the prepregs may take the form of chopped fibers, continuous fibers, filaments, tows, bundles, sheets, plies, and combinations thereof. Continuous fibers may further adopt any of unidirectional (aligned in one direction), multi-directional (aligned in different directions), non-woven, woven, knitted, stitched, wound, and braided configurations, as well as swirl mat, felt mat, and chopped mat structures. Woven fiber structures may comprise a plurality of woven tows, each tow composed of a plurality of filaments, e.g., thousands of filaments.

In one aspect, the carbon fibers have a tensile strength of from about 1000 MPa to about 7,000 MPa as determined by TY-030B-01, or about 1000 MPa, 1500 MPa, 2000 MPa, 2500 MPa, 3000 MPa, 3500 MPa, 4000 MPa, 4500 MPa, 5000 MPa, 5500 MPa, 6000 MPa, 6500 MPa, or 7000 MPa, where any value can be a lower and upper endpoint of a range (e.g., 3000 MPa to 6500 MPa).

In another aspect, the carbon fibers have a density of from about 1.5 g/cm³ to about 2.5 g/cm³ as determined by TY-030B-02, or about 1.5 g/cm³, 1.6 g/cm³, 1.7 g/cm³, 1.8 g/cm³, 1.9 g/cm³, 2.0 g/cm³, 2.1 g/cm³, 2.2 g/cm³, 2.3 g/cm³, 2.4 g/cm³, or 2.5 g/cm³, where any value can be a lower and upper endpoint of a range (e.g., 1.9 g/cm³ to 1.9 g/cm³).

In another aspect, the carbon fibers have a thermal conductivity of from about 5 W/m·K to about 1000 W/m·K, or about 5 W/m·K, 5 W/m·K, 50 W/m·K, 100 W/m·K, 200 W/m·K, 300 W/m·K, 400 W/m·K, 500 W/m·K, 600 W/m·K, 700 W/m·K, 800 W/m·K, 900 W/m·K, or 1,000 W/m·K, where any value can be a lower and upper endpoint of a range (e.g., 500 W/m·K to 800 W/m·K).

In another aspect, the carbon fibers are Toray M30S polyacrylonitrile (PAN) based carbon fiber plain weave (PW) manufactured by Toray.

In another aspect, the carbon fibers comprise pitch-based carbon fibers. In one aspect, pitch-based carbon fibers can be isotropic-pitch-based or anisotropic mesophase-pitch-based. Pitch-based carbon fibers possess high thermal conductivity as well as high strength and modulus of elasticity.

In one aspect, the pitch-based carbon fibers have a thermal conductivity of from about 500 W/m·K to about 1,000 W/m·K, or about 500 W/m·K, 550 W/m·K, 600 W/m·K, 650 W/m·K, 700 W/m·K, 750 W/m·K, 800 W/m·K, 850 W/m·K, 900 W/m·K, 950 W/m·K, or 1,000 W/m·K, where any value can be a lower and upper endpoint of a range (e.g., 600 W/m·K to 800 W/m·K).

In one aspect, the pitch-based carbon fibers have a tensile modulus of from about 50 GPa to about 1,000 GPa, or about 50 GPa, 100 GPa, 200 GPa, 300 GPa, 400 GPa, 500 GPa, 600 GPa, 700 GPa, 800 GPa, 900 GPa, or 1,000 GPa, where any value can be a lower and upper endpoint of a range (e.g., 300 GPa to 800 GPa).

In another aspect, the pitch-based carbon fibers have a tensile strength of up to 1,000 MPa, up to 2,000 MPa, up to 3,000 MPa, or up to 4,000 MPa.

In another aspect, the pitch-based carbon fibers have a density of from about 1.75 g/cm³ to about 2.50 g/cm³ or about 1.75 g/cm³, 2.00 g/cm³, 2.25 g/cm³, or 2.50 g/cm³, where any value can be a lower and upper endpoint of a range (e.g., 2.00 g/cm³ to 2.25 g/cm³).

In another aspect, the pitch-based is GRANOC manufactured by Nippon Graphite Fiber Corporation.

In one aspect, the resin in the second substrate with the carbon fibers is a multifunctional epoxy resin (or polyepoxide) having a plurality of epoxide functional groups per molecule. The polyepoxide may be saturated, unsaturated, cyclic, or acyclic, aliphatic, aromatic, or hetero-cyclic polyepoxide compounds. Examples of suitable polyepoxides include the polyglycidyl ethers, which are prepared by reaction of epichlorohydrin or epibromohydrin with a polyphenol in the presence of alkali. Suitable polyphenols therefore are, for example, resorcinol, pyrocatechol, hydroquinone, bisphenol A (bis(4-hydroxyphenyl)-2,2-propane), bisphenol F (bis(4-hydroxyphenyl)-methane), fluorine 4,4′-dihydroxy benzophenone, bisphenol Z (4,4′-cyclohexy-lidene-bisphenol) and 1,5-hyroxynaphthalene.

In one aspect, the curable resin in the substrate, barrier ply, bonding ply and optional joining ply is diglycidyl ethers of bisphenol A or bisphenol F (e.g., EPON™ 828 liquid epoxy resin), DER 331, DER 661 (solid epoxy resins) available from Dow Chemical Co.; triglycidyl ethers of aminophenol (e.g., ARALDITE®. MY 0510, MY 0500, MY 0600, MY 0610 from Huntsman Corp.). Additional examples include phenol-based novolac epoxy resins, commercially available as DEN 428, DEN 431, DEN 438, DEN 439, and DEN 485 from Dow Chemical Co.; cresol-based novolac epoxy resins commercially available as PMT F7, ECN 1235, ECN 1273, and ECN 1299 from Ciba-Geigy Corp.; hydrocarbon novolac epoxy resins commercially available as TACTIX® 71756, TACTIX®556, and TACTIX®756 from Huntsman Corp. In some embodiments, the epoxy resin may be DER 331, which is the reaction product of epichlorohydrin and bisphenol A. The tradename DER 331 is also commonly known as bisphenol A diglycidyl ether or 2,2′-(((propane-2,2-diylbis(4,1-phenylene))bis(oxy))bis(methylene))bis(oxirane).

In one aspect, the curable resin in the second substrate is a tetrafunctional epoxy such as 4,4′-methylenebis(N,N-diglycidylaniline) or a trifunctional epoxy such as N,N-diglycidyl-4-glycidyloxyaniline supplied by Kaneka North America. In another aspect, the curable resin in the second substrate is a mixture of 4,4′-methylenebis(N,N-diglycidylaniline) and N,N-diglycidyl-4-glycidyloxyaniline. In another aspect, the curable resin in the second substrate is a diglycidyl ether of bisphenol A or bisphenol F. In another aspect, the curable resin in the second substrate is a tetraglycidyl methylenedianiline (e.g., Hexcel 8552). In another aspect, the curable resin in the second substrate is a diglycidylaminophenyl glycidyl ether.

The amount of curable resin present in the second substrate can vary. In one aspect, the amount of curable resin present in the second substrate is from about 30 wt % to about 95 wt %, or about 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, or 95 wt %, where any value can be a lower and upper endpoint of a range (e.g., 40 wt % to 75 wt %).

The thickness of the second substrate can vary depending upon the application of the composite. In one aspect, the second substrate has a thickness of from about 5 μm to about 500 μm, or about 5 μm, 10 μm, 50 μm, 100 μm, 150 μm, 200 μm, 250 μm, 300 μm, 350 μm, 400 μm, 450 μm, or 500 μm, where any value can be a lower and upper endpoint of a range (e.g., 50 μm to 250 μm).

In one aspect, the curable resin includes nanomaterials. Not wishing to be bound by theory, the nanomaterials in the resin can enhance mechanical interface and through-thickness thermal conductivity of the composites described herein. In one aspect, the nanomaterials include carbon nanotubes, graphene, boron nanotubes, silver nanowires, gold nanowires, or any combination thereof. In another aspect, the carbon nanotubes are multi-walled carbon nanotubes (MWCNT) or single-walled carbon nanotubes (SWCNT). In one aspect, the diameter of the MWCNT can be from about 5 nm to about 100 nm. In one aspect, the diameter of the SWCNT can be from about 0.5 nm to about 5 nm.

In one aspect, the amount of the nanomaterials present in the resin is from about 0.1 wt % to about 20 wt %, or about 0.1 wt %, 1 wt %, 3 wt %, 5 wt %, 7 wt %, 9 wt %, 11 wt %, 13 wt %, 15 wt %, 17 wt %, or 20 wt %, where any value can be a lower and upper endpoint of a range (e.g., 3 wt % to 9 wt %).

In one aspect, the second substrate has a thermal conductivity of from about 25 W/m·K to about 200 W/m·K, or about 25 W/m·K, 50 W/m·K, 75 W/m·K, 100 W/m·K, 125 W/m·K, 150 W/m·K, 175 W/m·K, or 200 W/m·K, where any value can be a lower and upper endpoint of a range (e.g., 75 W/m·K to 125 W/m·K).

In certain aspects, the curable resin in the second substrate can include one or more additives, fillers, and fibers, such as, but not limited to, chopped or continuous glass fiber, metal fibers, aramid fibers, carbon fibers, or ceramic fibers, surfactants, organic binders, polymeric binders, crosslinking agents, diluents, coupling agents, flame-retardant agents, anti-dripping agents such as fluorinated polyolefins, silicones, and, lubricants, mold release agents such as pentaerythritol tetrastearate, nucleating agents, anti-static agents such as conductive blacks, carbon nanotubes, carbon nanofibers, graphite, graphene, oxidized graphene, boron nitride nanotubes, silver nanowires, gold nanowires, silver nanoparticles, gold nanoparticles and organic antistatic agents such as polyalkylene ethers, alkylsulfonates, perfluoro sulfonic acid, perfluorobutane, sulfonic acid potassium salt, and polyamide-containing polymers, catalysts, colorants, inks, dyes, antioxidants, stabilizers, and the like and any combinations thereof.

In one aspect, the additional components or additives can be from about 0.001 wt. % to about 1 wt. %, about 0.005 wt. % to about 0.9 wt. %, about 0.005 wt. % to about 0.8 wt. %, or about 0.04 wt. % to about 0.8 wt. % of the curable resin in the second substrate, and in particular embodiments, the additional components or additives may make up about 0.04 wt. % to about 0.6 wt. % based on the curable resin in the second substrate. Additional components such as glass fiber, carbon fiber, boron fiber, boron nitride fiber, boron carbide fiber, silicon nitride fiber, silicon carbide fiber, organic fiber, ceramic fiber or other fillers may be provided at much higher concentrations up to 70 volume (vol.) %.

For example, the curable resin in the second substrate may include about 5 vol. % to about 70 vol. %, from about 10 vol. % to about 60 vol. %, or about 20 vol. % to about 50 vol. % glass fiber, carbon fiber, organic fiber, or ceramic fiber.

In one aspect, curing agents (or curatives) can slow the cure rate of the curable resin. The curatives may be selected from well-known curatives with reactivities that are well established. For instance, curatives for epoxy resins in order of increasing curing rate are generally classified as: polymercaptan<polyamide<aliphatic polyamine<aromatic polyamine derivatives<tertiary amine boron trifluoride complex<acid anhydride<imidazole<aromatic polyamine<cyanoguanadine<phenol novolac. This list is only a guide and overlap within classifications exists. Curatives of the surface treatment layer are generally selected from groups that are listed towards the higher end of the reaction order, whereas the composite substrate's curatives may be generally selected from groups towards the beginning of the reaction order.

Curing agents, curing catalysts, and curing accelerators known in the art such useful herein include, but are not limited to, transition metal catalysts, tertiary amines, imidazole containing compounds, and the like and combinations thereof. Examples of the tertiary amine curing catalysts include triethylamine, benzyldimethylamine, pyridine, picoline, 1,8-diazabiscyclo(5,4,0)undecene-1, dicyandiamide, and the like, and Examples of the imidazole compound include, but are not limited to 2-methylimidazole, 2-ethylimidazole, 2-undecylimidazole, 2-ethyl-4-methylimidazole, 2-phenyl-4,5-dihydroxymethylimidazole, 2-phenyl imidazole, phosphonium salts like tetraphenyl phosphonium phenolate and ethyltriphenyl phosphonium bromide, tetrabutyl ammonium, 4-dimethylaminopyridine, and boron trifluoride-ethylamine complex and the like.

Some non-limiting examples of curatives that may be used include, but are not limited to, melamine and substituted melamine derivatives, aliphatic and aromatic primary amines, aliphatic and aromatic tertiary amines, boron trifluoride complexes, guanidines, dicyandiamide, bisureas (including 2,4-toluene bis-(dimethyl urea), commercially available as CA 150 from CVC Thermoset Specialties), 4,4′-Methylene bis-(phenyl dimethylurea), e.g. CA 152 from CVC Thermo-set Specialties), 4,4′-diaminodiphenylsulfone (4,4-DDS), and combinations thereof.

Cure inhibitors are molecules that slow the rate of reaction between the curable resins and curatives. Examples of suitable cure inhibitors include, but are not limited to, boric acid, trifluoroborane, and derivatives thereof such as alkyl borate, alkyl borane, trimethoxyboroxine and organic acids having a pKa from 1 to 3 such as maleic acid, salicyclic acid, oxalic acid and mixtures thereof. Other inhibitors include metal oxides, metal hydroxides, and alkoxides of metal, where the metal is zinc, tin, titanium, cobalt, manganese, iron, silicon, boron, or aluminum. When such inhibitor is used, the amount of inhibitor may be up to about 15 parts per hundred parts of resin or PHR, for example, about 1 to about 5 PHR, in a resin composition. “PHR” is based on the total weight of all resins in the resin composition.

Catalysts facilitate the polymerization and crosslinking reactions of the curable resins. Some examples of suitable catalysts include compounds containing amine, phosphine, heterocyclic nitrogen, ammonium, phosphonium, arsenium, or sulfonium moieties. In other embodiments, heterocyclic nitrogen-containing and amine-containing compounds may be used such as, for example, imidazoles, imidazolidines, imidazolines, benzimidazoles, oxazoles, pyrroles, thiazoles, pyridines, pyrazines, morpholines, pyridazines, pyrimidines, pyrrolidines, pyrazoles, quinoxalines, quinazolines, phthalozines, quinolines, purines, indazoles, indoles, indolazines, phenazines, phenarsazines, phenothiazines, pyrrolines, indolines, piperidines, piperazines, and combinations thereof. When such catalysts are used, the amount of catalyst(s) may be up to about 15 parts per hundred parts of resin or PHR, for example, about 1 to about 5 PHR, in a resin composition.

The amount of the curing catalyst may be any amount that is effective for use as a catalyst and can, generally, be from about 0.01 wt. % to about 20 wt. % based on the weight of the total composition. In some embodiments, the amount of curing catalyst may be, about 0.1 wt. % to about 15 wt. %, about 0.5 wt. % to about 10 wt. %, about 1.0 wt. % to about 5 wt. %, or any range or individual concentration encompassed by these example ranges.

Inorganic fillers in particulate form (e.g., powder) may also be added to the curable resins as a rheology modifying component to control the flow of the resin composition and to prevent agglomeration therein. Suitable inorganic fillers include, but are not limited to, fumed silica, talc, mica, calcium carbonate, alumina, ground or precipitated chalks, quartz powder, zinc oxide, calcium oxide, and titanium dioxide. If present, the amount of fillers in the resin composition may be from about 0.5% to about 40% by weight, or about 1% to about 10% by weight, or about 1% to about 5% by weight, based on the total weight of the resin composition.

Organic fillers may also be added to the curable resins in order to modify the mixing and flow of the resin. In one aspect, the organic filler can possess functional groups that react with the curable resin. For example, the organic filler can be a thermoplastic polymer with functional groups (e.g., amine groups) incorporated in the polymer backbone and/or pendant to the polymer backbone that can react with functional groups (e.g., epoxy groups) in the curable resin.

Applications of the Composites

The composites described herein have unique properties that make them suitable to be incorporated in numerous devices where it is desirable to have high thermal conductivity. In one aspect, the composites can be used in aerospace structures. In another aspect, the composites can be a component of a radiator, a heat exchange system, a solar array, a payload boom, or an aerospace CO₂ removal system. The composites described herein are highly durable. For examples, as demonstrated in the Examples, the composites described herein have excellent space environment durability when exposed to space conditions (e.g., high vacuum, ultraviolet (UV) light, atomic oxygen (AO), radiation, etc).

Thermal radiation is the main mode of thermal energy transfer via emission of electromagnetic wave in the vacuum of the space. The composites described herein have a thermal conductivity that is at least 10 times, at least 20 times, at least 30 times, or up to 40 times greater than that of only carbon fibers.

In one aspect, the composite has a thermal conductivity of from about 20 W/m·K to about 1,000 W/m·K, or about 20 W/m·K, 50 W/m·K, 100 W/m·K, 200 W/m·K, 300 W/m·K, 400 W/m·K, 500 W/m·K, 600 W/m·K, 700 W/m·K, 800 W/m·K, 900 W/m·K, 1,000 W/m·K, 1,500 W/m·K, 2,000 W/m·K, or 2,500 W/m·K, where any value can be a lower and upper endpoint of a range (e.g., 200 W/m·K to 2,500 W/m·K). In another aspect, the composite has an in-plane thermal conductivity of from about 20 W/m·K to about 2,500 W/m·K, or about 20 W/m·K, 50 W/m·K, 100 W/m·K, 200 W/m·K, 300 W/m·K, 400 W/m·K, 500 W/m·K, 1,000 W/m·K, 1,500 W/m·K, 2,000 W/m·K, or 2,500 W/m·K, where any value can be a lower and upper endpoint of a range (e.g., 200 W/m·K to 400 W/m·K). In another aspect, the composite has an out-of-plane thermal conductivity of from about 0.05 W/m·K to about 2,500 W/m·K, or about 0.05 W/m·K, 0.10 W/m·K, 0.15 W/m·K, 0.20 W/m·K, 0.25 W/m·K, 0.30 W/m·K, 0.35 W/m·K, 0.40 W/m·K, 0.45 W/m·K or 0.50 W/m·K, 1,000 W/m·K, 1,500 W/m·K, 2,000 W/m·K, or 2,500 W/m·K, where any value can be a lower and upper endpoint of a range (e.g., 0.25 W/m·K to 0.45 W/m·K). Non-limiting methods for determining the thermal conductivities of the composites described herein are provided in the Examples.

The thermal emissivity of the composites described herein make them suitable for numerous applications. In one aspect, the composite has a thermal emissivity of from about 0.25 to about 1.50 at a wavelength of from 3 μm to about 30 μm, or 0.25, 0.50, 0.75, 1.00, 1.25, or 1.50, where any value can be a lower and upper endpoint of a range (e.g., 0.50 to 1.25). Non-limiting methods for determining the thermal emissivity of the composites described herein are provided in the Examples.

When an object is exposed to sun light, the solar absorptivity of material is another key parameter to determine the thermal equilibrium in space. In one aspect, the composites described herein have a solar absorptivity of from about 0.50 to about 3.00 at a wavelength of from 250 nm to about 2,500 nm, or 0.25, 0.50, 0.75, 1.00, 1.25, 1.50, 1.75, 2.00, 2.25, 2.50, 2.75, or 3.00 where any value can be a lower and upper endpoint of a range (e.g., 0.50 to 2.25). Non-limiting methods for determining the solar absorptivity of the composites described herein are provided in the Examples.

### Aspects

Aspect 1. A composite comprising:
a first substrate having a first side and a second side, wherein the first substrate comprises a first pyrolytic graphite sheet, and
a second substrate having a first side and a second side, wherein the second substrate comprises carbon fibers and a resin,
wherein the first side the second substrate is adjacent to and adhered to the second side of the first substrate by the resin.

Aspect 2. The composite of Aspect 1, wherein the composite further comprises a third substrate having a first side and a second side, wherein the third substrate comprises carbon fibers and a resin, wherein the first side the third substrate is adjacent to and adhered to the first side of the first substrate.

Aspect 3. The composite of Aspect 1, wherein the composite further comprises a third substrate having a first side and a second side, wherein the third substrate comprises a second pyrolytic graphite sheet, wherein the first side the third substrate is adjacent to and adhered to the second side of the second substrate.

Aspect 4. The composite of any one of Aspects 1 to 3, wherein the pyrolytic graphite sheet is a sheet having a thickness of from about 10 micrometers to about 150 micrometers.

Aspect 5. The composite of any one of Aspects 1 to 3, wherein the pyrolytic graphite sheet comprises a plurality of holes.

Aspect 6. The composite of any one of Aspects 1 to 4, wherein the pyrolytic graphite sheet has an in-plane thermal conductivity of from about 300 W/m·K to about 2,500 W/m·K.

Aspect 7. The composite of any one of Aspects 1 to 4, wherein the pyrolytic graphite sheet has a through-plane thermal conductivity of from about 1 W/m·K to about 40 W/m·K.

Aspect 8. The composite of any one of Aspects 1 to 4, wherein the pyrolytic graphite sheet has a thermal diffusivity of from about 5 cm²/s to about 20 cm²/s.

Aspect 9. The composite of any one of Aspects 1 to 4, wherein the pyrolytic graphite sheet has a density of from about 0.5 g/cc to about 2.5 g/cc.

Aspect 10. The composite of any one of Aspects 1 to 9, wherein the carbon fibers comprise chopped fibers, continuous fibers, filaments, tows, bundles, sheets, plies, and any combination thereof.

Aspect 11. The composite of any one of Aspects 1 to 9, wherein the carbon fibers comprise a woven or nonwoven fabric ply or continuous unidirectional fibers.

Aspect 12. The composite of any one of Aspects 1 to 11, wherein the carbon fibers have a tensile strength of from about 1000 MPa to about 7,000 MPa as determined by TY-030B-01.

Aspect 13. The composite of any one of Aspects 1 to 11, wherein the carbon fibers have a density of from about 1.5 g/cm³ to about 2.5 g/cm³ as determined by TY-030B-02.

Aspect 14. The composite of any one of Aspects 1 to 11, wherein the carbon fibers have a thermal conductivity of from about 5 W/m·K to about 1000 W/m·K.

Aspect 15. The composite of any one of Aspects 1 to 11, wherein the carbon fibers comprise pitch-based carbon fibers.

Aspect 16. The composite of Aspect 15, wherein the pitch-based carbon fibers have a modulus of less than 1,000 GPa.

Aspect 17. The composite of any one of Aspects 1 to 16, wherein the cured resin is derived from an epoxide resin.

Aspect 18. The composite of Aspect 17, wherein the epoxide resin is reaction of epichlorohydrin or epibromohydrin with a polyphenol.

Aspect 19. The composite of Aspect 17, wherein the epoxide resin is a diglycidyl ether of bisphenol A or bisphenol F.

Aspect 20. The composite of Aspect 17, wherein the epoxide resin is a tetraglycidyl methylenedianiline.

Aspect 21. The composite of Aspect 17, wherein the epoxide resin is a diglycidylaminophenyl glycidyl ether.

Aspect 22. The composite of any one of Aspects 1 to 16, wherein the cured resin is derived from thermosetting such as polyimide, bismaleimide, cyanate ester, etc. or thermoplastic such as polyetheretherketone, polyetherimide, polysulfone.

Aspect 23. The composite of any one of Aspects 1 to 22, wherein the weight percent of the carbon fibers to the cured resin in the second substrate is from about 30 weight percent to about 95 weight percent.

Aspect 24. The composite of any one of Aspects 1 to 23, wherein the cured resin further comprises nanomaterials comprising carbon nanotubes, carbon nanofibers, graphene, boron nanotubes, silver nanowires, gold nanowires, silver nanoparticles, gold nanoparticles or any combination thereof

Aspect 25. The composite of Aspect 24, wherein the nanomaterials are from about 0.1 weight percent to about 20 weight percent of the cured resin.

Aspect 26. A composite produced by the method comprising
(a) coupling a first substrate with a second substrate to produce a first stack, wherein the first substrate has first side and a second side, wherein the first substrate comprises a pyrolytic graphite sheet, and the second substrate has a first side and a second side, wherein the second substrate comprises carbon fibers and a resin, and wherein the first side the second substrate is adjacent to the second side of the first substrate; and
(b) heating the first stack to adhere the first substrate with the second substrate to produce the composite.

Aspect 27. The composite of Aspect 26, wherein prior to step (a), the pyrolytic graphite sheet is exposed to ultraviolet light or surface plasma.

Aspect 28. The composite of Aspect 26, wherein prior to step (a), the pyrolytic graphite sheet is perforated.

Aspect 29. The composite of any one of Aspects 26 to 28, wherein the second substrate has a thermal conductivity of from about 25 W/m·K to about 2500 W/m·K.

Aspect 30. The composite of any one of Aspects 26 to 29, wherein the first stack is heated at a temperature of from about 70° C. to about 300° C.

Aspect 31. The composite of any one of Aspects 1 to 30, wherein the composite has a thermal conductivity that is at least 10 times greater than that of only the carbon fibers.

Aspect 32. The composite of any one of Aspects 1 to 30, wherein the composite has a thermal conductivity of from about 20 W/m·K to about 25000 W/m·K.

Aspect 33. The composite of any one of Aspects 1 to 30, wherein the composite has an in-plane thermal conductivity of from about 20 W/m·K to about 2500 W/m·K.

Aspect 34. The composite of any one of Aspects 1 to 30, wherein the composite has an out-of-plane thermal conductivity of from about 0.05 W/m·K to about 2,500 W/m·K.

Aspect 35. The composite of any one of Aspects 1 to 30, wherein the composite has a thermal emissivity of from about 0.25 to about 1.50 at a wavelength of from 3 μm to about 30 μm.

Aspect 36. The composite of any one of Aspects 1 to 30, wherein the composite has a solar absorptivity of from about 0.50 to about 3.00 at a wavelength of from 250 nm to about 2,500 nm.

Aspect 37. A device comprising the composite of any one of Aspects 1 to 36.

Aspect 38. The device of Aspect 37, wherein the device is a radiator, a heat exchange system, a solar array, a payload boom, or an aerospace CO₂ removal system.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure.

### Experimental

A. Materials

Novolac epoxy (PMT F7) resin and spread-tow, carbon fiber reinforced epoxy prepreg [Toray M30S polyacrylonitrile (PAN) based carbon fiber plain weave (PW) fabric/epoxy (PMT-F7)] were obtained from Patz Materials and Technology (CA, USA) and used as the baseline composite material. Methyl ethyl ketone (MEK) (Sigma-Aldrich, MO, USA) was used as received to make dilute PMT F7 resin solutions. Several grades of pyrolytic graphitic sheets (PGS) were obtained from two vendors. One set was manufactured by Panasonic Industry (Japan) and the other was manufactured by HPMS Graphite (CA, USA). Pitch based carbon fiber fabrics [Nippon Graphite Fiber (NGF) PF(S)-YSH50A(1k)-75, PF(S)-YSH70A(1k)-75, PF(S)-YS80A(1.5k)-140, SF-YS95A(3k)-200, Japan] were obtained from CST Composite Store (CA, USA). The predetermined amount of PMT F7 solution was painted onto the pitch based NGF carbon fiber fabric to fabricate a “pre-infused” CF/PMT F7 epoxy prepreg sheet with the desired mass fraction (about 50%) of carbon fiber after drying in a convection oven at 60° C. for 3 hours, followed by a 50° C. in vacuo overnight soak. The dried prepreg and PGS were stacked according to the predetermined layup configuration and cured in an autoclave at 110° C. for 1 hour. A pressure of 0.7 MPa was applied and the autoclave was heated at a rate of 3° C./min to 177° C. and held for 2 hours and cooled to ambient temperature. The pressure was then released.

B. Characterization

Thermal conductivity of PGS and hybrid CF/PGS epoxy composites under ambient conditions were measured using a Hot Disk Thermal Constants Analyzer (TPS 2500S, Hot Disk AB, Sweden) with model 5465, 5501, 7280, 7577 and 102003 sensors. The “slab” mode was employed for measuring in-plane thermal conductivity. Time and heating power for measurement were 1 second to 2 seconds and 25 mW to 300 mW depending on specimen thickness. For out-of-plane conductivity, the “thin film” mode was selected with the measurement time of 10 seconds to 20 seconds and the larger heating power of about 0.8 W to 2 W depending on specimen thickness. Aluminum 6061 T6 was used as a reference material.

The morphology of the sample was studied using a field-emission scanning electron microscope (FE-SEM, S-5200, Hitachi High-Tech, Japan). The accelerating voltage and beam current were 25 KeV to 30 KeV and 17 μA to 20 μA, respectively. The specimens were polished as needed using a polisher (Ecomet Polisher, Buehler, IL, USA). The thermo-optical properties [thermal emissivity (ϵ_{T}) and solar absorptivity (αₛ)] were measured using a portable emissometer (TEMP 2000, AZ Technology, AL, USA) in a wavelength range (λ) of 3 μm to 30 μm and a laboratory portable spectroreflectometer (LPSR 300, AZ Technology, Al, USA) in a wavelength range of 250 nm to 2500 nm.

### Results

A. Hybrid CF/PGS Composite Fabrication

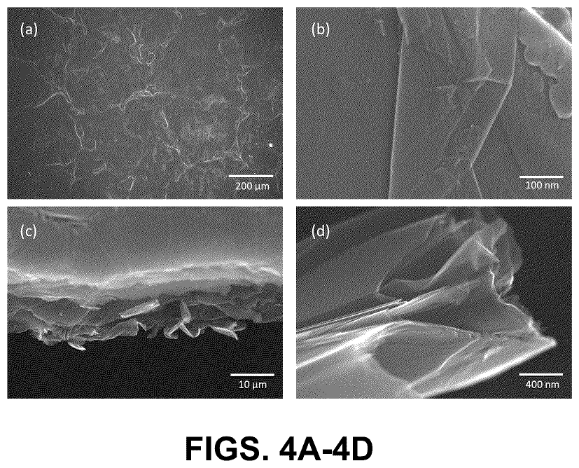

PGS is a pyrolytic graphite sheet which consists of highly oriented graphene multilayers. It has high thermal conductivity from 400 W/m·K to 1950 W/m·K, which is up to about five times higher than copper (386 W/m·K) and up to about eight times higher than aluminum (251 W/m·K). The PGS appearance is a dark shade of gray with a partially reflective smooth surface. Four grades of PGS were tested in this study. They were 25 μm and 70 μm thick Panasonic PGS sheets, and 25 μm and 40 μm thick HPMS PGS sheets (Table 1). The SEM images in FIG. 2 show the microstructure of PGS 70. Overlays of multiple pieces of thin graphene layer were found in the surface morphology (FIGS. 4A-4B). The PGS was fractured in liquid nitrogen and the cross-sectional morphology was investigated (FIGS. 4C-4D) and it was found that the PGS consisted of thin graphene multilayers.

TABLE 1

| Sample ID | Specification |
|---|---|
| Al 6061 | Aluminum 6061 |
| PGS 25 | Panasonic PGS (25 μm thick) |
| PGS 70 | Panasonic PGS (70 μm thick) |
| HPGS 25 | HPMS PGS (25 μm thick) |
| HPGS 40 | HPMS PGS (40 μm thick) |
| CF-Ep | PAN based carbon fiber (M30S) plain weave fabric - Epoxy |
| | (PMT F7) composite, 3 plies, [0-90]₃ |
| CF-Ep/PGS 25/CF-Ep | CF-Ep, [0-90], 1 ply/PGS 25, 1 ply/CF-Ep, [0-90], 1 ply |
| PGS 25/CF-Ep/PGS 25 | PGS 25, 1 ply/CF-Ep, [0-90], 1 ply/PGS 25, 1 ply |
| CF-Ep/PGS 70/CF-Ep | CF-Ep, [0-90], 1 ply/PGS 70, 1 ply/CF-Ep, [0-90], 1 ply |
| PGS 70/CF-Ep/PGS 70 | PGS 70, 1 ply/CF-Ep, [0-90], 1 ply/PGS 70, 1 ply |
| PGS 70/CF/PGS 70 | PGS 70/CF/PGS 70 |
| CNT_CF-Ep | PAN based carbon fiber (M30S) plain weave fabric - Epoxy |
| | (PMT F7) composite doped with 2 wt % carbon nanotubes |
| | (CNT), [0/90], 1 ply |
| p-PGS 70 | Perforated PGS 70 |
| CNT_CF-Ep/p-PGS 70/ | CNT_CF-Ep, 1 ply/p-PGS 70, 1 ply/CNT_CF-Ep, 1 ply |
| CNT_CF-Ep | |
| PCF1-Ep | Pitch based carbon fiber (YS50A) satin weave fabric - |
| | Epoxy (PMT F7) composite, 2 plies, [45]₄ |
| PCF2-Ep | Pitch based carbon fiber (YS75A) plain weave fabric - |
| | Epoxy (PMT F7) composite, 2 plies, [0-90]₂ |
| PCF3-Ep | Pitch based carbon fiber (YS80A) plain weave fabric - |
| | Epoxy (PMT F7) composite, 2 plies, [0-90]₂ |
| PCF4-Ep | Pitch based carbon fiber (YS95A) plain weave fabric - |
| | Epoxy (PMT F7) composite, 4 plies, [0-90]₂ |
| PCF4-Ep/HPGS 40/PCF4-Ep | PCF4-Ep, [0-90], 1 ply/HPGS 40, 1 ply/PCF4-Ep, [0-90], |
| | 1 ply |

The hybrid CF/PGS composites were fabricated by laying PGS and CF-epoxy prepreg sheets alternatively. Two layup configurations of the hybrid CF/PGS composites (CF-epoxy/PGS/CF-epoxy composite and PGS/CF-epoxy/PGS composite) were prepared. All the composites are flexible. The sample ID and specification are summarized in Table 1.

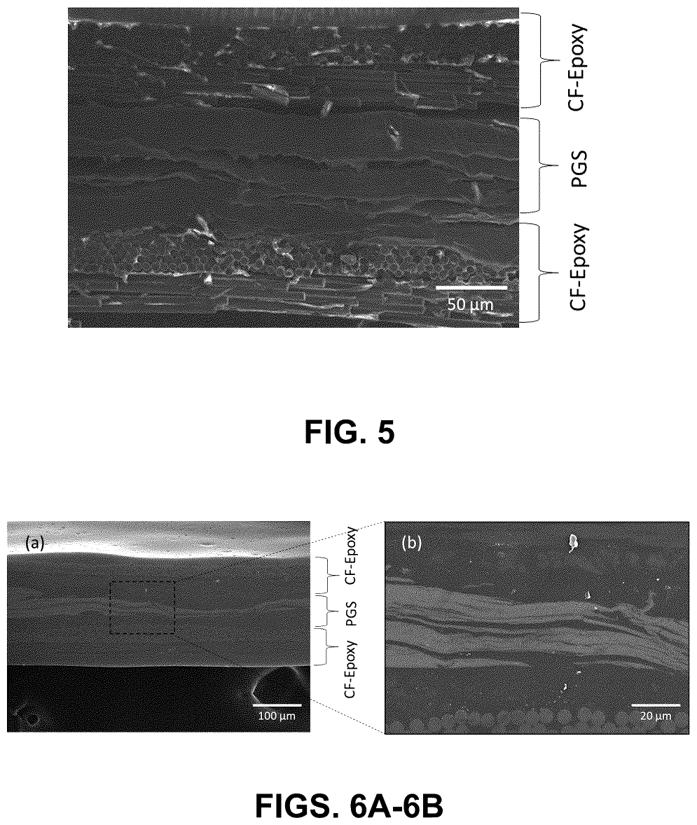

Cross-sectional micrography was performed to investigate the layered structure of the hybrid CF/PGS epoxy composite. The specimen was fractured in liquid nitrogen and the surface was investigated using SEM. The morphology shown in FIG. 5 is the rough fracture surface of CF-epoxy layers for top and bottom and PGS layer in the middle of specimen. However, the interface between the layers could not be clearly identified. Therefore, the fractured sample was polished. The polished cross-section of fracture surface was clearly shown in FIG. 6. Good infusion of epoxy resin at the interfaces between CF and PGS as well as clear morphology of CF and PGS were found in the hybrid CF/PGS epoxy composite.

B. Thermal Conductivity Characterization

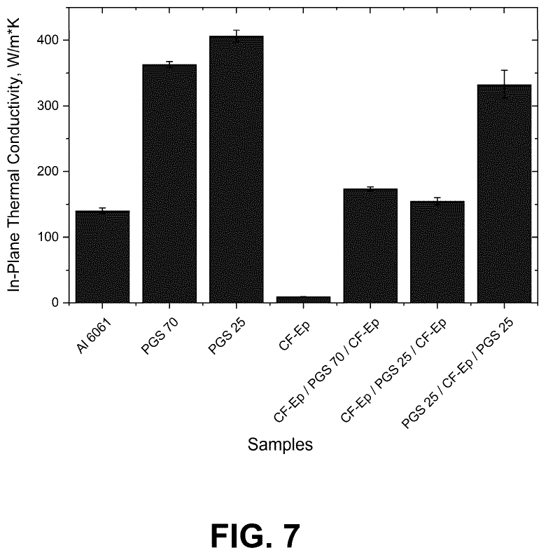

The thermal conductivities of the prepared hybrid PGS/CF epoxy composite were measured by the hot disk method. The hot disk technique has been used to study isotropic and anisotropic bulk thermal transport of materials.¹⁶⁻¹⁸ This technique utilizes a “disk” shape sensor which applies the current to make the sensor and material “hot” according to Joule's heating. By monitoring the voltage and current variation over time which are dependent on the material properties, the thermal properties of material were calculated. This technique has the advantages of being able to measure the thermal conductivity, thermal diffusivity, and specific heat capacity of as-prepared materials in solids, liquids, and powders. The in-plane thermal conductivity was measured using the “slab” mode. The in-plane thermal conductivity of PGS 25 and PGS 70 were about 362 W/m·K to 406 W/m·K, and that of HPGS 25 and HPGS 40 were about 501 W/m·K to 544 W/m·K. Thinner PGS has slightly higher thermal conductivity. The baseline CF-Epoxy composite has a thermal conductivity of about 9 W/m·K. When it was laminated with PGS25, the thermal conductivity increased dramatically. The thermal conductivities of CF-Epoxy/PGS 25/CF-Epoxy and PGS 25/CF-Epoxy/PGS 25 were about 155 W/m·K and 333 W/m·K, respectively, as shown in FIG. 7. These values are up to about 140% higher than the reference aluminum 6061 (about 140 W/m·K, measured using the isotropic mode) and 3500% higher than the baseline CF-Epoxy composite. The in-plane thermal conductivity of the composite with PGS 70, CF-Epoxy/PGS 70/CF-Epoxy, was about 174 W/m·K, higher than CF-Epoxy/PGS 25/CF-Epoxy composite. The higher thermal conductivity of CF-Epoxy/PGS 70/CF-Epoxy seems to originate from the higher thermal transport through thicker PGS, because the difference in thermal conductivity of PGS 25 and PGS 70 is small. The error bars in the graph represented the standard deviation of the measured values showing the good reliability of experiments.

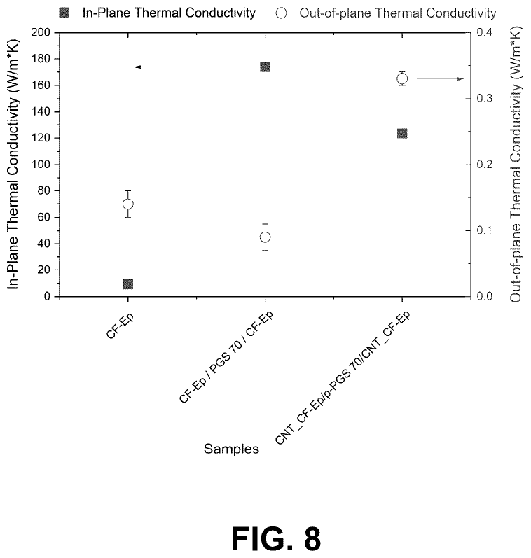

The out-of-plane thermal conductivities of the hybrid composites were measured using the “thin film” mode. The thin film mode was designed for measuring the out-of-plane thermal conductivity of thin film or coating which is thinner than 500 μm by measuring the thermal resistance. The thickness of test samples was about 210 μm to 220 μm. The out-of-plane thermal conductivity of the baseline CF-Epoxy composite was measured to be 0.14 W/m·K (FIG. 8 and Table 2). To improve the out-of-plane thermal conductivity, carbon nanotubes (CNTs) were infused in the epoxy resin and PGS was perforated for better through-thickness thermal transport by allowing resin and CNTs to flow between layers. The CNTs infusion in CF-epoxy resin and lamination of the perforated PGS improved the out-of-plane thermal conductivity by about 14000 (Δ˜0.19 W/m·K) as shown in FIG. 7, but it is still significantly lower than in-plane thermal conductivities.

TABLE 2

| | | Out-of-plane |
|---|---|---|
| | | Thermal |
| | In-Plane Thermal | Conductivity |
| Sample | Conductivity (W/m · K) | (W/m · K) |
| Al 6061 | 140.48 ± 4.45 | — |
| PGS 25 | 406.32 ± 8.95 | — |
| PGS 70 | 362.66 ± 4.44 | — |
| HPGS 25 | 533.92 ± 16.16 | — |
| HPGS 40 | 501.12 ± 9.94 | — |
| CF-Ep | 9.25 ± 0.01 | 0.14 ± 0.02 |
| CF-Ep/PGS 25/CF-Ep | 154.75 ± 5.57 | 0.24 ± 0.01 |
| PGS 25/CF-Ep/PGS 25 | 332.62 ± 21.33 | 0.04 ± 0.00 |
| CF-Ep/PGS 70/CF-Ep | 173.85 ± 2.89 | 0.09 ± 0.02 |
| CNT_CF-Ep/p-PGS 70/ | 123.56 ± 0.96 | 0.33 ± 0.01 |
| CNT_CF-Ep | | |
| PCF1-Ep | 26.55 ± 0.60 | |
| PCF2-Ep | 42.38 ± 0.50 | |
| PCF3-Ep | 75.67 ± 0.90 | 0.23 ± 0.00 |
| PCF4-Ep | 89.48 ± 1.71 | 0.12 ± 0.00 |
| PCF4-Ep/HPGS 40/PCF4-Ep | 143.1 ± 2.64 | 0.31 ± 0.01 |

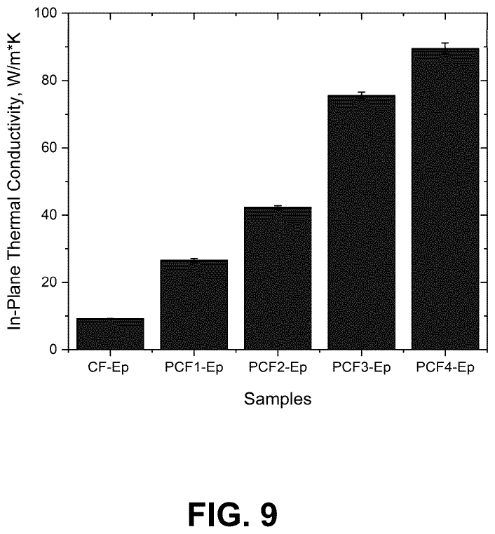

The effect of various carbon fibers on the thermal conductivity of composites was investigated using pitch-based carbon fiber (FIG. 9). Four different grades of pitch-based carbon fiber fabrics [PF(S)-YSH50A(1k)-75, PF(S)-YSH70A(1k)-75, PF(S)-YS80A(1.5k)-140 and SF-YS95A(3k)-200] were used to fabricate the hybrid CF/PGS epoxy composites (Table 1). The pitch-based CF-epoxy composite was found to have about 190% to 870% higher thermal conductivities (about 27 W/m·K to 89 W/m·K) compared to the PAN based CF-epoxy composite (CF-Ep). Thermal conductivity of higher modulus CF (YS95A, 972 GPa) epoxy composite (PCF4-Ep) was measured to be about 89 W/m·K whereas the thermal conductivity of lower modulus CF (YS50A, 524 GPa) epoxy composite (PCF1-Ep) was measured to be about 27 W/m·K. When PGS (HPGS 40) was laminated with PCF4, the thermal conductivity was about 143 W/m·K.

C. Thermal Optical Properties

Thermal radiation is the main mode of thermal energy transfer via emission of electromagnetic wave in the vacuum of the space, governed by Planck's law and Stefan-Boltzmann's law, and is dependent on the thermal emissivity of materials. Thus, the thermal emissivity of a material is important to estimate the total emissive power from the radiator. The thermal emissivity of PGS ranges from about 0.32 to 0.34 as shown in FIG. 9 and Table 3. The thermal emissivities of CF-epoxy laminated PGS, CF-Epoxy/PGS 25 (or PGS 70)/CF-Epoxy were measured to be about 0.74 to 0.76. The thermal emissivity of PGS laminated on CF-Epoxy layer was about 0.30, which is similar to that of PGS itself, because PGS is exposed to free space. The infusion of CNT into epoxy resin increased the thermal emissivity to about 0.89, which is similar to the commercial coating, Aeroglaze Z307 (ϵ_{T}˜0.89). This means CNT infused CF-Epoxy Composite radiator may eliminate the need for additional black thermal coating.

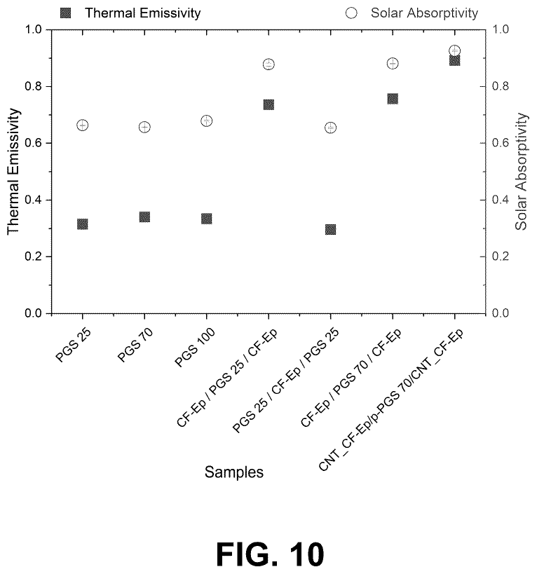

When an object is exposed to sun light, the solar absorptivity of material is another key parameter to determine the thermal equilibrium in space. Therefore, the solar absorptivity was measured using a spectroreflectometer. The solar absorptivity of samples was higher than the thermal emissivity as shown in FIG. 10 9 and Table 3. The solar absorptivity of PGS and PGS laminated CF-Epoxy composite (PGS 25/CF-Ep/PGS 25) ranges from about 0.66 to 0.68. The solar absorptivity of CF-epoxy laminated PGS composites [CF-Epoxy/PGS 25 (or PGS 70)/CF-Epoxy] and CNT infused CF-Epoxy composite was measured to be about 0.88 to 0.93. The ratio αₛ,/ϵ_{T} is higher than 1.0. This result indicated that white thermal coating, optical solar reflector (OSR) or second surface mirror (SSM) which has low αₛ and high ϵ_{T} will be required for the Sun-facing surface of the composite radiator.

TABLE 3

| | Thermal | | |
|---|---|---|---|
| | Emissivity | Solar Absorptivity | |
| | (ε_{T}, λ: 3 μm to 30 | (α_{S}, λ: 250 nm to 2500 | |
| Sample | μm) | nm) | α_{S}, /ε_{T} |
| PGS 25 | 0.315 + 0.001 | 0.664 + 0.001 | 2.108 |
| PGS 70 | 0.340 + 0.000 | 0.657 + 0.001 | 1.932 |
| PGS 100 | 0.334 + 0.001 | 0.679 + 0.003 | 2.033 |
| CF-Ep/PGS 25/CF-Ep | 0.736 + 0.000 | 0.878 + 0.005 | 1.193 |
| PGS 25/CF-Ep/PGS 25 | 0.296 + 0.001 | 0.665 + 0.003 | 2.247 |
| CF-Ep/PGS 70/CF-EP | 0.757 + 0.000 | 0.881 + 0.001 | 1.164 |
| CNT_CF/p-PGS 70/ | 0.892 + 0.001 | 0.926 + 0.003 | 1.038 |
| CNT_CF-Ep | | | |

The highly thermally conductive composites are tested in low earth orbit (LEO) under Material International Space Experiments (MISSE) 17 mission. Samples are installed to Zenith direction of MISSE Flight Facility (FF), and exposed to direct space environment (high vacuum, ultraviolet (UV) light, atomic oxygen (AO), radiation, etc) at about 409 km altitude. No significant damage was found after 60 days exposure.

### CONCLUSION

Highly thermally conductive composites for potential radiator and heat exchanger applications were fabricated with various carbon fiber (CF) fabrics and pyrolytic graphite sheets (PGS). The pitch-based CF-epoxy composites were found to have about an 870% improvement in thermal conductivity compared to PAN based-CF-epoxy composites. The in-plane thermal conductivity of the PGS laminated CF-epoxy composites was about 333 W/m·K, 3500% higher than the baseline CF-Epoxy composite and about 140% higher than the reference aluminum 6061. Thermal emissivity of the CF-Epoxy/PGS composites varied from about 0.32 to 0.76 based on the exposed material. The addition of CNT in CF-Epoxy resin increased the thermal emissivity to about 0.89 and might eliminate the use of black thermal coating (high FT) for the back side of a radiator. However, the solar absorptivity of composite was about 0.67 to 0.93 and the ratio αₛ,/ϵ_{T} is higher than 1.0.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

1. Kang, J. H., Cano, R. J., Ratcliffe, J. G., Luong, H., Grimsley, B. W., and Siochi, E. J., “Multifunctional Hybrid Carbon Nanotube/Carbon Fiber Polymer Composites,” SAMPE 2016, Society for the Advancement of Material and Process Engineering, Long Beach, C A, 2016, pp. 15.
2. Hone, J., Liaguno, M. C., Nemes, N. M., Johnson, A. T., Fischer, J. E., Walters, D. A., Casavant, M. J., Schmidt, J., and Smalley, R. E., “Electrical and Thermal Transport Properties of Magnetically Aligned Single Wall Carbon Nanotube Film,” Applied Physical Letters, Vol. 77, Iss. 5, 2000, pp. 666-668.
3. Kim, P., Shi, L., Majumdar, A., and McEuen, P. L., “Thermal Transport Measurements of Individual Multiwalled Nanotubes,” Physical Review Letters, Vol. 87, 2001, pp. 215502.
4. Ghose, S., Working, D. C., Connell, J. W., Smith, J. G., Watson, K. A., Delozier, D. M., Sun, Y. P, and Lin, Y., “Thermal Conductivity of Ultem™/Carbon Nanofiller Blends,” High Performance Polymers, Vol., 18, Iss. 6, 2006, pp. 961-977.
5. Kalaitzidou, K., Fukushima, H., and Drzal, L. T., “Multifunctional Polypropylene Composites Produced by Incorporation of Exfoliated Graphite Nanoplatelets,” Carbon, Vol. 45, 2007, pp. 1446-1452.
6. Inagaki, M., Kaburagi, Y., and Hishiyama, Y., “Thermal Management Material: Graphite,” Advanced Engineering Materials, Vol. 16, No. 5., pp. 494-506.
7. Murakami, M., Watanabe, K., and Yoshimura, S., “High-Quality Pyrographite Films,” Applied Physics Letters, Vol. 48, 1986, pp. 1594.
8. Nagano, H., Ohnishi, A., and Nagasaka, Y., “Thermophysical Properties of High-Thermal-Conductivity Graphite Sheets for Spacecraft Thermal Design,” Journal of Thermophysics and Heat Transfer, Vol. 15, No. 3, 2001, pp. 347-353.
9. Mena, F., and Benthem, B., Airbus Defense and Space SAS, Toulouse, France, US Patent for “Flexible Radiative Fin for a Spacecraft,” U.S. Pat. No. 11,254,452, issued 21 Jun. 2019.
10. Mass, A., “Development of Pyrolytic Graphite Applications in Spacecraft Thermal Control Systems,” 47^{th} International Conference on Environmental System Proceedings, ICES, Charleston, SC, July 2017.
11. De Groot, T., Schwieters, B., Van Benthem, R., Van Es, Johannes, and Pauw, A., “Breadbod Testing of a HiPeR Inflatable Radiator (HiPeR INFRA),” 49^{th} International Conference on Environmental Systems, ICES, Boston, M A, 2019.
12. Belancik, G., Jan, D., and Huang, R., “Spacecraft Carbon Dioxide Deposition Subscale System Design and Test,” International Conference on Environmental Systems Proceedings, ICES, Boston, MA, July 2019.
13. Belancik, G., Schuh, M., Jan, D., and Jagtap, P., “Evaluation Capabilities of the Carbon Dioxide Deposition System,” 50^{th} International Conference on Environmental Systems Proceedings, ICES, online, July 2020.
14. Jagtap, P., Belancik, G., Jan, D., Chen, W., and Hall, S., “Power Optimization of Cryogenic CO₂ Deposition Capture in Deep Space,” 50^{th} International Conference on Environmental Systems Proceedings, ICES, online, July 2020.
15. Jagtap, P., Costa, T., Belancik, G., Schuh, M., Samson, J., Gan, K., “Spacecraft Carbon Dioxide Deposition Full-Scale System: Design, Analysis, Build and Test,” 52^{nd}International Conference on Environmental Systems Proceedings, ICES, Calgary, Canada, July 2023 (to be published).
16. Gustafsson, S. E., “Transient Plane Source Techniques for Thermal Conductivity and Thermal Diffusivity Measurements of Solid Materials,” Review of Scientific Instruments, Vol. 62, No. 3, 1991, pp. 797-804.
17. Log, T., and Gustafsson, S. E., “Transient Plane Source (TPS) Technique for Measuring Thermal Transport Properties of Building Materials,” Fire and Materials, Vol. 19, No. 1, 1995, pp. 43-49.
18. Gustavsson, M., and Hälldahl, L., “Thermal Conductivity Measurement of Thin Insulating Layers Deposited on High-Conducting Sheets,” International Journal of Thermophysics, Vol. 27, No. 1, 2006, pp. 195-207.

What is claimed is:

1. A composite comprising:
a first substrate having a first side and a second side, wherein the first substrate comprises a first pyrolytic graphite sheet, and
a second substrate having a first side and a second side, wherein the second substrate comprises carbon fibers and a resin,
wherein the first side of the second substrate is adjacent to and adhered to the second side of the first substrate by the resin.

2. The composite of claim 1, wherein the composite further comprises a third substrate having a first side and a second side, wherein the third substrate comprises carbon fibers and a resin, wherein the first side of the third substrate is adjacent to and adhered to the first side of the first substrate.

3. The composite of claim 1, wherein the composite further comprises a third substrate having a first side and a second side, wherein the third substrate comprises a second pyrolytic graphite sheet, wherein the first side of the third substrate is adjacent to and adhered to the second side of the second substrate.

4. The composite of claim 1, wherein the first pyrolytic graphite sheet is a sheet having a thickness of from about 10 micrometers to about 150 micrometers.

5. The composite of claim 1, wherein the first pyrolytic graphite sheet comprises a plurality of holes.

6. The composite of claim 1, wherein the first pyrolytic graphite sheet has
an in-plane thermal conductivity of from about 300 W/m·K to about 2,500 W/m·K;
a through-plane thermal conductivity of from about 1 W/m·K to about 40 W/m·K;
a thermal diffusivity of from about 5 cm²/s to about 20 cm²/s; and
a density of from about 0.5 g/cc to about 2.5 g/cc.

7. The composite of claim 1, wherein the carbon fibers of the second substrate have
a tensile strength of from about 1000 MPa to about 7,000 MPa as determined by TY-030B-01;
a density of from about 1.5 g/cm³ to about 2.5 g/cm³ as determined by TY-030B-02; and
a thermal conductivity of from about 5 W/m·K to about 1000 W/m·K.

8. The composite of claim 1, wherein the carbon fibers of the second substrate comprise pitch-based carbon fibers.

9. The composite of claim 1, wherein the second substrate resin is cured resin and further comprises nanomaterials comprising carbon nanotubes, carbon nanofibers, graphene, boron nanotubes, silver nanowires, gold nanowires, silver nanoparticles, gold nanoparticles, or any combination thereof.

10. The composite of claim 9, wherein the nanomaterials are from about 0.1 weight percent to about 20 weight percent of the cured resin.

11. A composite produced by the method comprising
(a) coupling a first substrate with a second substrate to produce a first stack, wherein the first substrate has first side and a second side, wherein the first substrate comprises a pyrolytic graphite sheet, and the second substrate has a first side and a second side, wherein the second substrate comprises carbon fibers and a resin, and wherein the first side the second substrate is adjacent to the second side of the first substrate; and
(b) heating the first stack to adhere the first substrate with the second substrate to produce the composite.

12. The composite of claim 11, wherein prior to step (a), the pyrolytic graphite sheet is exposed to ultraviolet light or surface plasma.

13. The composite of claim 11, wherein prior to step (a), the pyrolytic graphite sheet is perforated.

14. The composite of claim 1, wherein the composite has a thermal conductivity that is at least 10 times greater than that of the carbon fibers alone.

15. The composite of claim 1, wherein the composite has an in-plane thermal conductivity of from about 20 W/m·K to about 2,500 W/m·K.

16. The composite of claim 1, wherein the composite has an out-of-plane thermal conductivity of from about 0.05 W/m·K to about 2,500 W/m·K.

17. The composite of claim 1, wherein the composite has a thermal emissivity of from about 0.25 to about 1.50 at a wavelength of from 3 μm to about 30 μm.

18. The composite of claim 1, wherein the composite has a solar absorptivity of from about 0.50 to about 3.00 at a wavelength of from 250 nm to about 2,500 nm.

19. A device comprising the composite of claim 1.

20. The device of claim 19, wherein the device is a radiator, a heat exchange system, a solar array, a payload boom, or an aerospace CO₂ removal system.
